(19) United States
(12) Patent Application Publication
(10) Pub. No.: US 2021/0080948 A1
(43) Pub. Date: Mar. 18, 2021

(54) VEHICLE CONTROL SYSTEM

(71) Applicant: Transportation IP Holdings, LLC, Norwalk, CT (US)

(72) Inventors: Adam Franco, Melbourne, FL (US); Adam Hausmann, Melbourne, FL (US); Daniel Rush, Saint Charles, IL (US); Derek Woo, Melbourne, FL (US); Robert Palanti, West Melbourne, FL (US); Nelyo Oliveira, Melbourne, FL (US); Carlos Paulino, Melbourne, FL (US); Marshall Tetterton, West Melbourne, FL (US); Maurice Hutchins, Mims, FL (US); Lee Covert, Port St. John, FL (US); Joseph Nazareth, Melbourne, FL (US)

(21) Appl. No.: 16/726,999

(22) Filed: Dec. 26, 2019

Related U.S. Application Data
(60) Provisional application No. 62/899,640, filed on Sep. 12, 2019.

(51) Int. Cl. G05D 1/00; G05D 1/02; H04W 4/021; H04B 7/185; B64C 39/02

(52) U.S. Cl. CPC G05D 1/0061; G05D 1/0214; G05D 1/0238; B64C 2201/122; H04W 4/021; H04B 7/18504; B64C 39/024; G05D 1/0022

(57) ABSTRACT

A vehicle control system and method determine that a vehicle moving in a manned operative state is approaching a defined zone. The vehicle is controlled based on manual input received from an operator onboard the vehicle while in the manned operative state. The system and method also switch the vehicle from the manned operative state to an unmanned operative state responsive to the vehicle approaching the defined zone and the operator disembarking from the vehicle. The movement of the vehicle is controlled in the unmanned operative state of the vehicle during travel of the vehicle inside the defined zone. The vehicle is autonomously controlled or remotely controlled while in the unmanned operative state.

### CROSS-REFERENCE TO RELATED APPLICATION

This application claims priority to U.S. Provisional Application No. 62/899,640, which was filed on 12 Sep. 2019, and the entire disclosure of which is incorporated herein by reference.

### BACKGROUND

Vehicles carry a variety of different categories of cargo through a wide variety of terrain. Travel through some areas and/or over some terrain can be hazardous. For example, it may be too dangerous for a manned vehicle to travel through some areas due to natural disasters. Additionally, these areas may not allow manned vehicles to legally travel through the areas due to the risk posed to humans onboard the vehicles.

This inability to travel with manned vehicles through some areas can significantly restrict operations of a transportation network and/or other facilities. For example, a town, mine, etc., that is accessed through such a dangerous area may be in accessible until the hazard has been eliminated. This can have a significantly negative impact on residents of the town, operation of the mine, etc.

### BRIEF DESCRIPTION

In one embodiment, a method includes determining that a vehicle moving in a manned operative state is approaching a defined zone. The vehicle is controlled based on manual input received from an operator onboard the vehicle while in the manned operative state. The method also includes, responsive to the vehicle approaching the defined zone and the operator disembarking from the vehicle, switching the vehicle from the manned operative state to an unmanned operative state and controlling the movement of the vehicle in the unmanned operative state of the vehicle during travel of the vehicle inside the defined zone. The vehicle is autonomously controlled or remotely controlled while in the unmanned operative state.

In one embodiment, a system includes one or more processors configured to determine that a vehicle moving in a manned operative state is approaching a defined zone. The vehicle is controlled based on manual input received from an operator onboard the vehicle while in the manned operative state. The one or more processors are configured to the vehicle from the manned operative state to an unmanned operative state responsive to the vehicle approaching the defined zone and the operator disembarking from the vehicle. The one or more processors also are configured to control the movement of the vehicle in the manned operative state of the vehicle during travel of the vehicle inside the defined zone. The one or more processors autonomously or remotely controlling the vehicle while the vehicle is in the unmanned operative state.

In one embodiment, a method includes determining that a manually controlled vehicle is not permitted to travel in a manned operative state within a defined zone, switching the vehicle from the manned operative state to an unmanned operative state, and autonomously or remotely controlling movement of the vehicle in during travel of the vehicle inside the defined zone.

### BRIEF DESCRIPTION OF THE DRAWINGS

The present inventive subject matter will be better understood from reading the following description of non-limiting embodiments, with reference to the attached drawings, wherein below:

FIG. 1 illustrates one example of a vehicle control system; and

FIG. 2 illustrates a flowchart of one embodiment of a method for controlling movement of an unmanned vehicle system in a defined zone.

### DETAILED DESCRIPTION

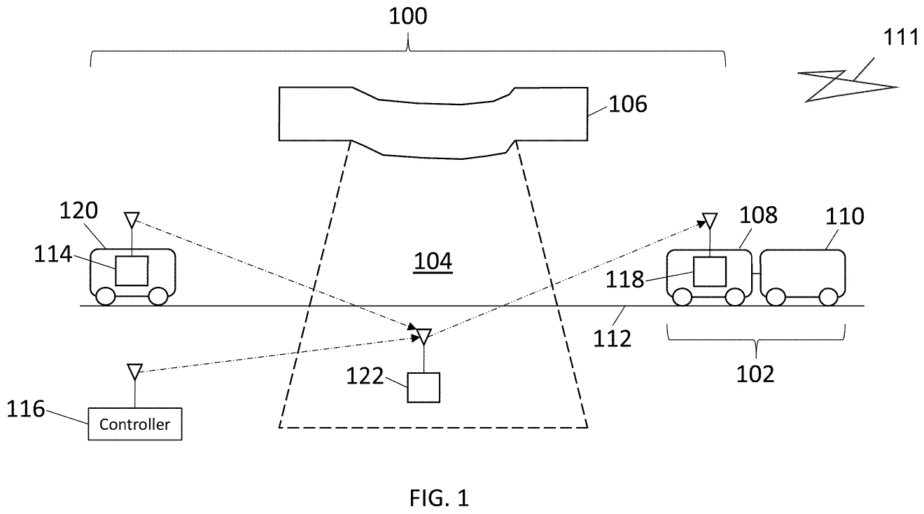

FIG. 1 illustrates one example of a vehicle control system 100. The vehicle control system operates a vehicle system 102 through a defined zone 104 (also referred to herein as a defined area). The defined zone may include a hazard area that is hazardous to people, to equipment, or to cargo. By hazardous, it is meant that some aspect of the environmental conditions within the defined zone differ from the conditions outside of the zone, and at least one of those conditions inside the zone may be injurious, deleterious, or undesirable to some object or aspect of the vehicle. In an exemplary embodiment, the hazardous area represents a spatial zone through which no person is allowed to be located or travel through. For example, the hazardous area can be a floodplain of a dam of levee 106 that is at risk of failing. Alternatively, the hazardous area can have or be associated with another type of hazard, as described herein. The operation may be autonomous, remote control, or another operation that differs from the operation of the vehicle system outside of the hazard area. In the exemplary embodiment, the vehicle system is an unmanned vehicle system (i.e., unmanned when controlled through the defined zone).

The vehicle system represents one or more vehicles 108, 110 that are capable of self-propulsion along one or more routes 112 through the defined zone. The vehicles in the vehicle system can include at least one propulsion-generating vehicle 108 and at least one non-propulsion-generating vehicle 110. Alternatively, the vehicle system may not include any non-propulsion-generating vehicle. The propulsion-generating vehicle can be a vehicle capable of generating tractive effort, propulsion, thrust, or the like for propelling the propulsion-generating vehicle along the route(s). For example, the propulsion-generating vehicle can be a land-based vehicle, such as a locomotive traveling along one or more rails or tracks, an automobile or truck traveling along one or more roads, a mining vehicle traveling along one or more paths, or another land-based vehicle. Other suitable propulsion-generating vehicles can be a non-land-based vehicle, such as a marine vessel traveling along one or more water routes or shipping lanes, an aircraft flying along one or more airborne routes, or the like.

The non-propulsion-generating vehicle, if present, can be a land, air, or water-based vehicle that is not capable of generating self-propulsion. Suitable non-propulsion-generating vehicles can be a rail car, a trailer that can couple with an automobile or truck, a barge, or the like. The propulsion-generating vehicle and/or the non-propulsion-generating vehicle can carry cargo. In one embodiment, the cargo does not include human passengers, but may include minerals, food, livestock, manufactured products, etc. Alternatively, the cargo may include passengers that do not control operation or movement of the vehicle system.

The propulsion-generating vehicle in the unmanned vehicle system does not include a human operator onboard the vehicle system in one embodiment. For example, the propulsion-generating vehicle may be automatically and/or remotely controlled to move along the routes by receiving control signals from a remotely located controller 114 and/or 116 of the control system. The controller 114 can be a controller located onboard another propulsion-generating vehicle 120. Alternatively, the controller 116 can be a controller that is not located onboard the other propulsion-generating vehicle. The other propulsion-generating vehicle can be the same type or category of vehicle as the vehicle 108 or may be another vehicle capable of self-propulsion.

The propulsion-generating vehicle may have an onboard control unit 118 that receives control signals from the remotely located controller. These control signals can dictate operational settings that control how the vehicle system is to move along the routes into, through, and/or out of the defined zone. For example, the control signals can direct which throttle settings or positions are to be used, which brake settings are to be used, moving speeds, accelerations, or the like, at one or more different times, locations, and/or distances along the routes. In one embodiment, the region around the vehicle may change from non-hazardous to hazardous. Accordingly, the vehicle may operate to leave the defined zone without having (knowingly) entered the defined zone. For example, the condition that caused the defined zone to become hazardous may move or cease to exist while the vehicle is moving toward, within, or out of the defined zone.

The controllers and control unit can each represent hardware circuitry that includes and/or is connected with one or more processors that operate to perform the functions described herein in connection with the respective controller or control unit. The processors can include one or more microprocessors, field programmable gate arrays, integrated circuits, or the like. The controllers and control unit can include or be connected with communication hardware, such as transceiving circuitry (e.g., antennas, modems, etc.) for wirelessly communicating the control signals between or among each other. Suitable sensors may be used either onboard the vehicle, or wayside of the route within the defined zone, or outside of the defined zone and in each case communicate directly or indirectly with the control unit. A location device may communicate with the control unit. Suitable location devices may include global positioning signal (GPS) devices, inertia and gyroscopic devices, laser range finders, beacons, time-of-flight devices, RADAR, LIDAR, and the like. The sensor package and the location device may be selected with reference to application specific parameters and requirements.

In one embodiment, the onboard and/or remotely located controllers can send the control signals to the control unit so that the unmanned vehicle system moves (according to and/or using the operational settings dictated by the control signals) along the one or more routes without any person being onboard the unmanned vehicle system. This can allow for the unmanned vehicle system and/or the cargo carried by the unmanned vehicle system to travel through and exit the defined zone without risking the safety of a human operator that otherwise would need to be onboard to control the vehicle system. For example, the unmanned vehicle system may be loaded with cargo (e.g., from a mine). Due to a natural disaster or other event causing a prohibition on human travel through the defined zone, the cargo may not otherwise be able to be transported out of or through the defined zone. The controller can send the control signals to the unmanned vehicle system to cause the unmanned vehicle system to automatically or autonomously move through and/or out of the defined zone, thereby bringing the cargo out of the defined zone.

The unmanned vehicle system can be directed (by the control signals) to move out of the defined zone to a location of the other propulsion-generating vehicle. For example, the controller(s) can direct the unmanned vehicle system to move, without an operator being located onboard the unmanned vehicle system, through and/or out of the defined zone. In one example, the unmanned vehicle system may be moved to the other propulsion-generating vehicle that is located outside of the defined zone. This other propulsion-generating vehicle may have one or more human operators onboard that control operation (e.g., movement) of the other propulsion-generating vehicle. The unmanned vehicle system can couple with the other propulsion-generating vehicle outside of the defined area so that the unmanned vehicle system and the other propulsion-generating vehicle form a manned vehicle system. This manned vehicle system has the one or more operators onboard that can control operation of the manned vehicle system to move to one or more additional locations. In doing so, the cargo carried by the unmanned vehicle system can be rescued from, or otherwise brought out of, the defined zone to join with the other propulsion-generating vehicle and taken to a destination location without risking the safety of any living being traveling through the defined zone. Optionally, the unmanned vehicle system may be autonomously and/or remotely controlled to move out of the defined zone, where an operator (e.g., the same operator that was onboard the vehicle system before entering the defined zone or a different operator) boards the vehicle system and begins controlling the vehicle system outside of the defined zone.

In one embodiment, the unmanned vehicle system may not be configured to be remotely controlled by control signals sent from the controller(s). For example, the control unit onboard the unmanned vehicle system may be configured for operating according to control signals received only from a controller onboard a vehicle that is mechanically coupled (directly or indirectly) with the vehicle in which the control unit is disposed. This can occur when the propulsion-generating vehicle(s) in the unmanned vehicle system are configured or set up for distributed power operation, but when none of the propulsion-generating vehicles are configured for or set up as a lead vehicle that controls operation of other vehicles. For example, all the propulsion-generating vehicles in the unmanned vehicle system may be configured or set up as trail or remote vehicles (that are controlled by a lead vehicle). The trail propulsion-generating vehicle(s) in the unmanned vehicle system can be controlled to move through and out of the hazardous area as trail or remote vehicles in a distributed power mode or arrangement, with the controller acting as the lead vehicle in the distributed power mode or arrangement (even though the controller is not onboard a vehicle that is mechanically coupled with the unmanned vehicle system). In this way, the control system operates in a way to mimic, imitate, or emulate operation of a vehicle system operating in a distributed power configuration, even though the vehicle system is separated into two (or more) parts and at least one part (e.g., the other propulsion-generating vehicle that is outside of the defined area) does not move while the unmanned vehicle system moves.

The controller(s) may directly communicate the control signals to the control unit. For example, the control signals may be wirelessly communicated from the controller to the control unit without the control signals being repeated by one or more other devices. This direct communication causes the controller(s) to operate as a communication device or devices, as the controller(s) are both originating the control signals and the last device to send the control signals to the control unit.

Alternatively, the control unit onboard the unmanned vehicle system may be too far from the controller to allow for direct communication of the control signals from the controller to the control unit. As a result, the controller(s) may not operate as a communication device. Instead, an external communication device 122 may repeat or otherwise forward the control signals from the controller(s) to the control unit. The communication device can represent transceiving circuitry that wirelessly communicates signals, such as one or more antennas, modems, or the like. The communication device can receive the control signal(s) from the controller and broadcast or transmit the control signal(s) to the control unit. In this way, the communication device may operate as a repeater of the control signals. The communication device operating as a repeater can spoof the control signals such that the control unit onboard the unmanned vehicle system treats the control signals as though the control signals were sent from a lead vehicle in a distributed power arrangement that includes the unmanned vehicle system.

The communication device may be a land-based device located in the hazardous area. For example, the communication device can be a wayside device located along or near the routes in the hazardous area. Alternatively, the communication device may be outside the hazardous area but be able to communicate with the unmanned vehicle system. In another embodiment, the communication device may be airborne. For example, the communication device may be onboard a manned or unmanned aerial vehicle 111, such as a plane, a drone, a blimp, a balloon, another vehicle, and the like. An aerial vehicle can move to a location over the hazardous area to allow for communication between the controller(s) and the control unit. This can allow for the communication device to be positioned in a location that cannot be reached by the vehicle that is outside the hazardous area (and to which the unmanned vehicle system travels). For example, the aerial vehicle may fly over or hover over the defined area. In another example, the aerial vehicle may track and follow the unmanned vehicle system to remain inside an envelope that allows for communication with both the unmanned vehicle and the controller (or a repeater). As another example, the aerial vehicle may transport and leave the communication device in a location allowing for communication with the controller(s) and the control unit. For example, the aerial vehicle can place the communication device at a high elevation (e.g., on a mountain, near or at the top of a tree, near or at the top of a tower, etc.).

While the defined area is described above as being a flood plain, an area under a flood watch, or an area of increased risk of a flood, alternatively, the defined area can have another risk or hazard. For example, the defined area can be an area of predicted or forecasted adverse weather conditions (e.g., tornadic activity, a hurricane, a tropical storm, a tsunami, high winds, etc.). As another example, the defined area can be an area contaminated by unsafe levels of radiation, an area experiencing fire or dense smoke (e.g., a forest fire), an area where a chemical spill occurred, an area where a gas leak occurred, and the like. The defined area can be an area having dangerous terrain. For example, the routes in the defined area may include bridges that are unsafe for human beings to travel over in vehicles, may be at elevated risks of rockslides, flood zones with uncertain infrastructure integrity, explosive mines (land or water), or the like. Alternatively, the defined zone may be part of a route where it is otherwise undesired to have persons onboard a vehicle system, e.g., because the vehicle system is required to move very slowly through the zone, because the operator of the vehicle system has to temporarily perform duties offboard the vehicle system, etc.

In one embodiment, the vehicle system may carry one or more auxiliary devices that perform functions during travel through or within the defined zone. For example, the vehicle system may include sensors that detect characteristics within the defined zone. These sensors may be grouped into sensor packages, and the sensors can obtain information about the defined zone in locations where a human operator cannot, should not, or is not permitted to travel. The vehicle system can be remotely controlled to move through the defined zone while the sensors collect information on the conditions within the defined zone. The sensor-collected information can be provided to the controllers or another device to determine the conditions within the defined zone. Examples of sensors include cameras, thermometers, wind gauges, radiation sensors, chemical analyte sensors, or the like. Some of these sensor packages provide data that allows for navigation and/or operation of the vehicle while in the defined zone.

While the above description focuses on remotely controlling the vehicle system to travel out of the defined zone or area, alternatively, the control system can operate to control the vehicle system to enter the defined area from outside of the defined area. For example, the controller can remotely control the vehicle system to enter the defined area to obtain sensor information (described above), to deliver products or substances in the defined area (e.g., to deliver water to a forest fire, to apply a chemical to neutralize a chemical spill, etc.), or the like.

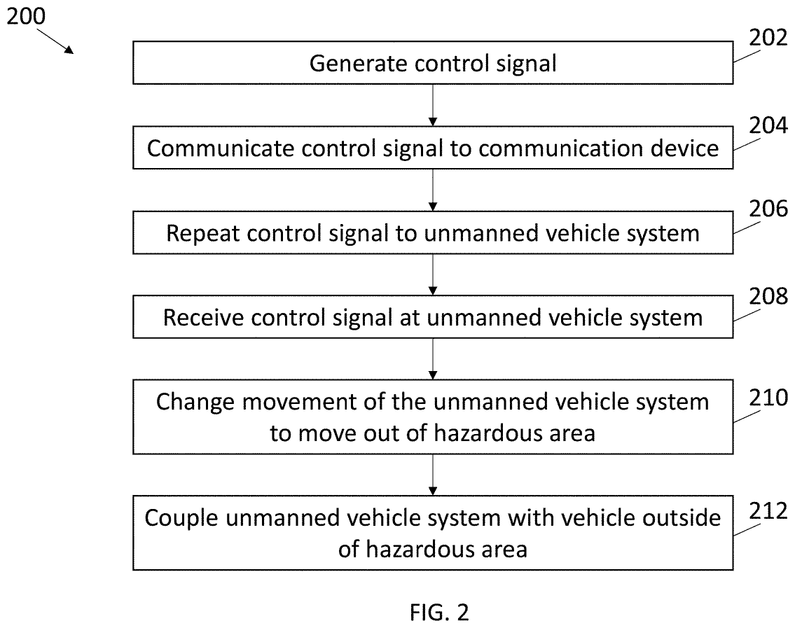

FIG. 2 illustrates a flowchart of one embodiment of a method 200 for controlling movement of a vehicle system in a defined zone. The method 200 can represent operations performed by the control system shown in FIG. 1 (in one embodiment). At 202, a control signal is generated at the controller. This control signal can dictate an operational setting to control movement of the vehicle system. The control signal can be generated by the controller onboard the vehicle that is outside of the defined zone and/or by the controller that is off-board the vehicle. At 204, the control signal is communicated to a communication device. For example, the control signal may be sent from the controller to the communication device that is closer to the vehicle system (than the controller) and/or that is within the defined zone. At 206, the control signal is repeated from the communication device to the control unit of the vehicle system. For example, the communication device may repeat the control signal without altering the control signal so that the control unit of the vehicle system treats the control signal as being received by a lead propulsion-generating vehicle that is coupled with the vehicle system. Alternatively, the control signal can be sent directly from the controller to the control unit without being repeated at one (or more) communication devices. At 208, the control unit of the vehicle system receives the control signal. At 210, movement of the vehicle system changes based on the control signal that is received. For example, the vehicle system may begin moving, change speed, change direction, or the like. The movement of the vehicle system can cause the vehicle system to travel to the vehicle that is outside of the defined zone. At 212, the vehicle system couples with the manned vehicle that is outside of the defined zone. The combined vehicle and vehicle system can now be a manned vehicle system with one or more operators onboard the manned vehicle. The combined vehicle system can then travel to one or more additional locations.

In one embodiment, a method includes determining that a vehicle moving in a manned operative state is approaching a defined zone. The vehicle is controlled based at least in part on manual input received from an operator onboard the vehicle while in the manned operative state. The method also includes, responsive to the vehicle approaching the defined zone and the operator disembarking from the vehicle, switching the vehicle from the manned operative state to an unmanned operative state and controlling the movement of the vehicle in the unmanned operative state of the vehicle during travel of the vehicle inside the defined zone. The vehicle is autonomously controlled or remotely controlled while in the unmanned operative state.

Optionally, the method also includes, responsive to the vehicle exiting the defined zone, switching the vehicle from the unmanned operative state to the manned operative state. The vehicle is controlled based on manual input received from the operator or another operator that boarded the vehicle subsequent to the vehicle exiting the defined zone.

Optionally, the method also includes receiving sensor data from one or more sensors. The sensor data may be indicative of one or more characteristics inside the defined zone. The movement of the vehicle may be controlled in the unmanned operative state using the sensor data.

Optionally, the method also includes monitoring a location of the vehicle moving in the unmanned operative state within the defined zone using the sensor data.

Optionally, the method also includes determining a presence of a hazard to continued travel of the vehicle moving in the unmanned operative state within the defined zone using the sensor data.

Optionally, the method also includes automatically changing the movement of the vehicle moving in the unmanned operative state within the defined zone based on the presence of the hazard that is determined.

Optionally, controlling the movement of the vehicle in the unmanned operative state of the vehicle during travel of the vehicle inside the defined zone includes sending a control signal from a controller outside of the defined zone to a repeater device located in the defined zone and repeating the control signal from the repeater device to the vehicle.

Optionally, the method also includes positioning the repeater device within the defined zone using an unmanned aerial vehicle.

Optionally, the method also includes moving the repeater device with the unmanned aerial vehicle to track the movement of the vehicle in the defined zone.

Optionally, the repeater device is one of several repeater devices in different locations in the defined zone. The method also can include sending the control signal to different ones of the repeater devices as the vehicle moves through the defined zone based on the locations of the repeater devices.

In one embodiment, a system includes one or more processors configured to determine that a vehicle moving in a manned operative state is approaching a defined zone. The vehicle is controlled based on manual input received from an operator onboard the vehicle while in the manned operative state. The one or more processors are configured to switch the vehicle from the manned operative state to an unmanned operative state responsive to the vehicle approaching the defined zone and the operator disembarking from the vehicle. The one or more processors also are configured to control the movement of the vehicle in the manned operative state of the vehicle during travel of the vehicle inside the defined zone. The one or more processors autonomously or remotely controlling the vehicle while the vehicle is in the unmanned operative state.

Optionally, the one or more processors are configured to, responsive to the vehicle exiting the defined zone, switch the vehicle from the unmanned operative state to the manned operative state and to control the vehicle based on manual input received from the operator or another operator that boarded the vehicle subsequent to the vehicle exiting the defined zone.

Optionally, the one or more processors are configured to receive sensor data from one or more sensors. The sensor data may be indicative of one or more characteristics inside the defined zone. The one or more processors may be configured to control the movement of the vehicle in the unmanned operative state using the sensor data.

Optionally, the one or more processors are configured to monitor a location of the vehicle moving in the unmanned operative state within the defined zone using the sensor data.

Optionally, the one or more processors are configured to determine a presence of a hazard to continued travel of the vehicle moving in the unmanned operative state within the defined zone using the sensor data.

Optionally, the one or more processors are configured to automatically change the movement of the vehicle moving in the unmanned operative state within the defined zone based on the presence of the hazard that is determined.

In one embodiment, a method includes determining that a manually controlled vehicle is not permitted to travel in a manned operative state within a defined zone, switching the vehicle from the manned operative state to an unmanned operative state, and autonomously or remotely controlling movement of the vehicle in during travel of the vehicle inside the defined zone.

Optionally, the method also includes, responsive to the vehicle exiting the defined zone, switching the vehicle from the unmanned operative state to the manned operative state. The vehicle may be controlled based on manual input received from the operator or another operator that boarded the vehicle subsequent to the vehicle exiting the defined zone.

Optionally, controlling the movement of the vehicle in the unmanned operative state of the vehicle during travel of the vehicle inside the defined zone includes sending a control signal from a controller outside of the defined zone to a repeater device located in the defined zone and repeating the control signal from the repeater device to the vehicle.

Optionally, the method also includes positioning the repeater device within the defined zone using an unmanned aerial vehicle.

In another embodiment, a method includes, with a controller onboard a first vehicle system located outside a defined zone, remotely or autonomously controlling a second vehicle system for travel through the defined zone. While the second vehicle system is traveling through the defined zone, the second vehicle system is unmanned and not physically coupled to the first vehicle system; also, during this time the first vehicle system may be stationary.

In another embodiment, the method further includes transmitting control signals from the first vehicle system to a repeater, for the repeater to repeat the control signals to the second vehicle system. The repeater is located offboard both the first vehicle system and the second vehicle system. The repeater may be affixed to a land surface, or carried by an unmanned or other aerial vehicle, or the like.

In another embodiment, prior to being controlled by the first vehicle system for travel through the defined zone, the method includes switching the second vehicle system from operating as (or including) a distributed power lead vehicle to operating as a distributed power remote vehicle.

The above description is illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-language equivalents of the respective terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format unless and until such claim limitations expressly use the phrase “means for” followed by a statement of function void of further structure.

This written description uses examples to disclose several embodiments of the inventive subject matter, including the best mode, and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, or the like). Similarly, the programs may be stand-alone programs, may be incorporated as subroutines in an operating system, may be functions in an installed software package, or the like. The various embodiments are not limited to the arrangements and instrumentality shown in the drawings.

What is claimed is:

1. A method comprising:
determining that a vehicle moving in a manned operative state is approaching a defined zone, the vehicle controlled based at least in part on manual input received from an operator onboard the vehicle while in the manned operative state;
responsive to the vehicle approaching or entering the defined zone and the operator disembarking from the vehicle, switching the vehicle from the manned operative state to an unmanned operative state; and
controlling movement of the vehicle in the unmanned operative state of the vehicle during travel of the vehicle inside the defined zone, the vehicle autonomously controlled or remotely controlled while in the unmanned operative state.

2. The method of claim 1, further comprising:
responsive to the vehicle exiting the defined zone, switching the vehicle from the unmanned operative state to the manned operative state, the vehicle controlled based at least in part on manual input received from the operator or another operator that boarded the vehicle subsequent to the vehicle exiting the defined zone.

3. The method of claim 1, further comprising:
receiving sensor data from one or more sensors, the sensor data indicative of one or more characteristics inside the defined zone,
the movement of the vehicle controlled in the unmanned operative state using the sensor data.

4. The method of claim 3, further comprising:
monitoring a location of the vehicle moving in the unmanned operative state within the defined zone using the sensor data.

5. The method of claim 3, further comprising:
determining a presence of a hazard to continued travel of the vehicle moving in the unmanned operative state within the defined zone using the sensor data.

6. The method of claim 5, further comprising:
automatically changing the movement of the vehicle moving in the unmanned operative state within the defined zone based on the presence of the hazard that is determined.

7. The method of claim 1, wherein controlling the movement of the vehicle in the unmanned operative state of the vehicle during travel of the vehicle inside the defined zone includes sending a control signal from a controller outside of the defined zone to a repeater device located in the defined zone and repeating the control signal from the repeater device to the vehicle.

8. The method of claim 7, further comprising:
positioning the repeater device within the defined zone using an unmanned aerial vehicle.

9. The method of claim 8, further comprising:
moving the repeater device with the unmanned aerial vehicle to track the movement of the vehicle in the defined zone.

10. The method of claim 7, wherein the repeater device is one of several repeater devices in different locations in the defined zone, and further comprising:
sending the control signal to different ones of the repeater devices as the vehicle moves through the defined zone based on the locations of the repeater devices.

11. The method of claim 1, wherein the vehicle is remotely controlled in the unmanned operative state of the vehicle during travel of the vehicle inside the defined zone by a second vehicle located outside the defined zone.

12. A system comprising:
one or more processors configured to determine that a vehicle moving in a manned operative state is approaching a defined zone, the vehicle controlled based at least in part on manual input received from an operator onboard the vehicle while in the manned operative state, the one or more processors configured to switch the vehicle from the manned operative state to an unmanned operative state responsive to the vehicle approaching or entering the defined zone and the operator disembarking from the vehicle, the one or more processors also configured to control movement of the vehicle in the manned operative state of the vehicle during travel of the vehicle inside the defined zone, the one or more processors configured to autonomously or remotely control the vehicle while the vehicle is in the unmanned operative state.

13. The system of claim 12, wherein the one or more processors are configured to, responsive to the vehicle exiting the defined zone, switch the vehicle from the unmanned operative state to the manned operative state and to control the vehicle based at least in part on manual input received from the operator or another operator that boarded the vehicle subsequent to the vehicle exiting the defined zone.

14. The system of claim 12, wherein the one or more processors are configured to receive sensor data from one or more sensors, the sensor data indicative of one or more characteristics inside the defined zone, the one or more processors configured to control the movement of the vehicle in the unmanned operative state using the sensor data.

15. The system of claim 14, wherein the one or more processors are configured to monitor a location of the vehicle moving in the unmanned operative state within the defined zone using the sensor data.

16. The system of claim 14, wherein the one or more processors are configured to determine a presence of a hazard to continued travel of the vehicle moving in the unmanned operative state within the defined zone using the sensor data.

17. The system of claim 16, wherein the one or more processors are configured to automatically change the movement of the vehicle moving in the unmanned operative state within the defined zone based on the presence of the hazard that is determined.

18. A method comprising:
determining that a manually controlled vehicle is not permitted to travel in a manned operative state within a defined zone;
responsive to the determining, switching the vehicle from the manned operative state to an unmanned operative state; and
autonomously or remotely controlling movement of the vehicle in the unmanned operative state during travel of the vehicle inside the defined zone.

19. The method of claim 18, further comprising:
responsive to the vehicle exiting the defined zone, switching the vehicle from the unmanned operative state to the manned operative state, the vehicle controlled based at least in part on manual input received from the operator or another operator that boarded the vehicle subsequent to the vehicle exiting the defined zone.

20. The method of claim 18, wherein controlling the movement of the vehicle in the unmanned operative state of the vehicle during travel of the vehicle inside the defined zone includes sending a control signal from a controller outside of the defined zone to a repeater device located in the defined zone and repeating the control signal from the repeater device to the vehicle.

21. The method of claim 20, further comprising:
positioning the repeater device within the defined zone using an unmanned aerial vehicle.
